(19) United States
(12) Patent Application Publication
(10) Pub. No.: US 2021/0341850 A1
(43) Pub. Date: Nov. 4, 2021

(54) Magnetic Information Label and Use Thereof

(71) Applicant: Garnet GmbH, Graz (AT)

(72) Inventors: Konstantin A. SHAVRIN, Moscow (RU); Alexei V. KATUKHOV, Tula (RU); Aleksandr V. SOMOV, Zhukovskii Moskovskaya Obl. (RU)

(21) Appl. No.: 16/994,298

(22) Filed: Aug. 14, 2020

Related U.S. Application Data
(63) Continuation of application No. PCT/RU2018/000085, filed on Feb. 14, 2018.

(51) Int. Cl. G03G 5/16; G11B 11/105

(52) U.S. Cl. CPC G03G 5/16; G11B 11/10528; G11B 11/10591

(57) ABSTRACT

The present invention provides the ability to record information on a stationary magnetic information label. Magnetic information label is designed to record information on it by heating special areas of the label with electromagnetic radiation up to or above Curie temperature and/or magnetization relaxation temperature; such magnetic information label has a magnetic layer attached to a magnetic layer carrier. Product of thermal conductivity coefficient by density and specific thermal capacity of the magnetic layer carrier in such a label should be greater than product of thermal conductivity coefficient by density and specific thermal capacity of the magnetic layer. The technical result of the invention is to provide non-uniform heating of the magnetic layer with spatially structured electromagnetic radiation.

### RELATED APPLICATIONS

This Application is a Continuation Application of International Application PCT/RU2018/000085, filed on Feb. 14, 2018, which is incorporated herein by reference in its entirety.

### FIELD OF THE INVENTION

The present invention relates to the field of information technology including in particular magnetic information labels (data carriers).

### BACKGROUND OF THE INVENTION

A magnetic information label fabricated originally in the form of a tape and consequently coated on a product is known from the patent application US2008304893. Such label contains a magnetic layer that contains ferromagnetics. Information on this layer can be recorded using a magnetic field source usually called a magnetic head. During the recording process the labelled tape is pulled though a magnetic tape mechanism and the magnetic head modulates a magnetic field around the magnetic layer over time so that magnetic field structure on the magnetic track corresponds to the information being recorded. Information can be recorded simultaneously on one or more magnetic tracks, depending on magnetic head structure. If necessary, the tape can be pulled through again when the magnetic head is shifted in cross direction of the tape movement. The information is recorded on the adjacent magnetic track.

The recorded information can be read by moving the label or magnetic reading head relative to each other or by other methods of reading information from a stationary magnetic information label known from prior art.

Disadvantage of the magnetic information label described above is the need of using moving parts to record information on the label using the magnetic head.

### SUMMARY OF THE INVENTION

An object of this invention is to provide the ability to record information on a stationary magnetic information label.

The object of this invention is achieved by using of a magnetic information label designed to record information on it by heating special areas of the label with electromagnetic radiation up to or above Curie temperature and/or magnetization relaxation temperature; such magnetic information label has a magnetic layer attached to a magnetic layer carrier. Product of thermal conductivity coefficient by density and specific thermal capacity of the magnetic layer carrier in such a label should be greater than product of thermal conductivity coefficient by density and specific thermal capacity of the magnetic layer. This condition can be reformulated in such a way that coefficient of thermal activity of the magnetic layer carrier should be greater than that of the magnetic layer. Alternatively, this condition can be reformulated in such a way that thermal absorption coefficient of the magnetic layer carrier should be greater than that of the magnetic layer.

In a preferred implementation option thermal capacity of the magnetic layer carrier should be greater than that of the magnetic layer. For example, thickness of the magnetic label carrier may be greater than thickness of the magnetic layer. The label can be fabricated multilayered in which case the magnetic layer carrier may be a carrier layer of magnetic layer carrier. A label in this form may contain an additional adhesive layer applied to the carrier layer of the magnetic layer. Furthermore, the label may be fixed or affixed to the carrier magnetic layer fabricated in the form of a marked object or product.

Between the magnetic layer and the magnetic layer carrier an adhesive layer can be placed. In this case, product of thermal conductivity coefficient by density and specific thermal capacity of the adhesive layer is preferably greater than product of thermal conductivity coefficient by density and specific thermal capacity of the magnetic layer, and product of thermal conductivity coefficient by density and specific thermal capacity of the carrier is not less than product of thermal conductivity coefficient by density and specific thermal capacity of the adhesive layer.

The object of the present invention is also achieved by applying the magnetic information label (using any of the above mentioned options) that contains the magnetic layer attached to the magnetic layer carrier, whereas product of thermal conductivity coefficient by density and specific thermal capacity of the magnetic layer carrier is greater than product of thermal conductivity coefficient by density and specific thermal capacity of the magnetic layer, for the purpose of recording information on it by heating special areas of the label by electromagnetic radiation up to or above Curie temperature and/or magnetisation relaxation temperature.

Technical result of the present invention is providing the ability to record information on a stationary magnetic information label. Technical result is achieved due to the relationship between the thermal properties of the magnetic layer of the label and the magnetic layer carrier, which may be part of the label or represent the marked object or product on which the label is placed, which prevents the carrier from heating the areas that do not need to be heated while heating of those areas that need to be heated to provide a given structure of the magnetic field corresponding to the recorded information.

Due to the fact that spatial structure of electromagnetic radiation used for heating of various areas (pixels, domains) of the magnetic information label, in accordance with this invention, can have as thin as needed structure limited only by the wavelength of electromagnetic radiation; thanks to this invention it is possible to provide an additional technical result on such magnetic label in the form of increased density of recorded information (information density) limited only by thermal properties of the label's magnetic layer and the carrier, relationship between which, according to the present invention, further increases the information density of the label which distinguishes this invention from the prior art where information density depends on the size of the magnetic head elements that create magnetic field on magnetic tape which is several orders of magnitude larger than pixel size created by electromagnetic radiation

### DETAILED DESCRIPTION OF THE PREFERRED EMBODIMENTS

The present invention is intended to implement the possibility of recording information on a stationary magnetic information label. Magnetic information label contains a layer of substance that can change magnetization vector (its direction and/or magnitude) of its special areas (domains, pixels) if placed in a magnetic field and/or heated to or above the Curie temperature or magnetization compensation temperature. The said substance may be, for example, a polymer containing ferromagnetic particles inside a layer of that substance and/or on its surface, and/or other particles that have magnetization vector. This substance layer may be called a magnetic layer and/or an information layer.

The magnetic information label is generally designed as a flat object. The simplest magnetic information label structure can only contain the magnetic layer described above. That layer may be applied to other objects, such as packaging, goods and other items and products which may themselves be referred to as the carrier of the magnetic layer as well as labels in general.

In a more complicated structure the magnetic information label contains a carrier layer which represents the magnetic layer carrier and can be called a carrier layer. Accordingly, the magnetic layer described above is applied on this carrier layer. Such magnetic label can be inserted in or glued to other objects and for this purpose it can also be provided with an adhesive layer mainly on the side of the carrier layer where magnetic layer is absent. Other types of magnetic information label structures are also possible.

Magnetic data carriers can be used for various purposes, e.g. to identify items on which they are placed, such as goods, cargo, documents, security papers, banknotes etc. Magnetic data carriers can also be used to store information about the objects on which they are placed, e.g. their characteristics, applications, safety requirements, name of the manufacturer, directions for use and advertising information.

In most cases in order to record information on the magnetic information label a source of magnetic field is required generally a magnet, and in a preferred option an electromagnet. The use of electromagnet provides the ability to control the size and the direction of the magnetic field applied to the magnetic data carrier without mechanical movements of the magnetic field source only by turning on/off/switching electric current flowing in the electromagnet. This allows to minimize overall size of the device for recording information on the magnetic information label and ensures reliable operation of the device. Furthermore, electromagnet can be used to create, if necessary, a magnetic field of a magnitude higher than that of permanent magnets.

In some implementation options a magnetic field source may have several magnets including a number of electromagnets. For the purposes of this invention all magnets and electromagnets are deemed to be part of a unified source of magnetic field. If there are several magnets and/or electromagnets in a magnetic field source, some of them may form a magnetic field of one direction and/or magnitude, and others of another direction and/or magnitude. Furthermore, these magnets and/or electromagnets may conjointly form the magnetic field of one direction and/or magnitude. If only one magnet or electromagnet is present in a magnetic field source, it can form a magnetic field of both directions and/or magnitude.

The source of magnetic field must form a magnetic field in the area where the magnetic information label is located. This can be achieved in several ways. The first option: the source of magnetic field should be located at such a distance from the magnetic information label that makes it possible to create a magnetic field in the area of the magnetic information label sufficient enough to ensure remagnetization of needed areas (domains, pixels) of the magnetic information label. In case of using an electromagnet as a source of magnetic field it is possible to regulate the distance at which the required magnitude of magnetic field is created by changing intensity of electric current flowing through the electromagnet.

The second option: the source of magnetic field, such as an electromagnet, can be provided with a magnetic wire used to transfer magnetic field from the source of magnetic field to the location of the magnetic information label. Furthermore, magnetic wire can be combined with a magnetic field concentrator which will allow to concentrate all possible magnetic field from the source of the magnetic field in the volume designed to allocate the magnetic information label.

The process of writing information on the stationary magnetic information label presents certain challenge due to the fact that magnetic field formed by the source of magnetic field is extended enough and in this connection a separate element (area, pixel, domain) of established magnetization of the stationary fixed magnetic information label will be large enough, i.e. that reduces achievable density of recorded information. Furthermore, recording multiple information pixels (areas, domains, elements) on a magnetic information carrier requires movement of the source of magnetic field relative to the magnetic information label, which is usually implemented by transporting a magnetic tape or rotating a magnetic disk relatively to a low-mobile magnetic field source (magnetic head). It is also possible that the source of magnetic field will move relative to a stationary magnetic information label, but in a certain sense this can also be considered as moving the magnetic information label relative to the source of magnetic field.

The present invention allows to record information on the magnetic information label which does not move relative to the information recording device and, in particular, relative to the source of magnetic field. This eliminates the need to use moving parts in a recording device and simplifies the process of information recording. Since the source of magnetic field is stationary relative to the magnetic information label and has a sufficiently extended magnetic field it is necessary to provide a method of recording whereby the magnetic information label is located in a continuous uniform magnetic field. Recording of information in such a case should be provided by adjusting susceptibility parameter of the material constituting the magnetic layer to magnetic field (or by regulating magnetization retention parameter of the magnetic layer).

Such regulating of susceptibility parameter can be controlled by selective heating of the magnetic layer of the magnetic information label which material, when heated to or above a certain temperature called the Curie temperature (point), becomes susceptible to external magnetic field, and after cooling may preserve intensity of magnetization determined by that external magnetic field. In another option preserving intensity of magnetization of the magnetic layer can also be achieved by heating the magnetic layer material to or above the temperature at which self-compensation (relaxation) of magnetization occurs. The type of regulation can be selected depending on material properties of the magnetic layer.

For selective local or full heating of entire or some parts of magnetic information label (areas, domains, pixels) a source of electromagnetic radiation can be used. With such heating the magnetic layer can be heated to or above the Curie point or magnetization compensation temperature.

When the magnetic layer is heated up to or above the Curie point, the substance that forms this magnetic layer changes magnetization vector (its direction and/or magnitude) of its individual areas (domains, pixels) or entire information surface when it is placed in a magnetic field created, for example, by the source of magnetic field. When the magnetic layer is heated up to the magnetization compensation temperature, the magnetic moments of particles constituting the layer substance and previously oriented in a certain way that provided a given magnetization, unfold and mutually compensate the macroscopic magnetic moment or lose their magnetization.

In order to be able to record information in the form of a structured magnetic field (magnetization) of the magnetic information label, the electromagnetic radiation falling on the magnetic information label must be non-destructive. In preferred option electromagnetic radiation is optical radiation, thus ensuring a higher density of information recording compared to infrared radiation. Furthermore, radiation can be ultraviolet providing even higher density of information recording.

The structure of the magnetization (magnetic field) of the magnetic information label is set using spatially structured electromagnetic radiation, in particular, radiation modulated over a distance. When such spatially structured electromagnetic radiation hits the magnetic information label, the heating of the magnetic layer varies depending on how the electromagnetic radiation is dimensionally distributed: If it hits the magnetic information label, its magnetic layer heats up, and if there is little or no radiation coming in, there is little or no heating.

During sufficient exposure time when electromagnetic radiation hits the magnetic information label, the magnetic layer may be heated to or above the Curie temperature (point) or to or above the magnetization compensation temperature. Where there is little or no radiation coming in, the temperature will not raise up to the Curie temperature (point) or magnetization compensation temperature. In the latter case the magnetization of the magnetic layer of the magnetic information label becomes structured (in other words, spatially modulated), because in those places where heating has occurred the magnetization changes under influence of an external magnetic field or without such an action (in case of compensation of magnetization), and where heating has not occurred or has occurred insufficiently, the magnetization remains the same.

Consequently, information can be recorded on the magnetic information label in the form of magnetization structure which in one of directions can represent, for example, a sequence of areas with different magnetization intensities. Moreover, magnetization structure may be presented in a matrix form where information can be written in rows, columns or in a complex representation.

In particular case there may be two types of magnetization of areas of magnetic layer. For example, these may be areas with vectors of magnetization of two different directions, or areas with different magnetization magnitudes including with zero (compensated) magnetization and non-zero magnetization of a certain magnitude. Such magnetization structure of a magnetic information label with two types of magnetization areas in one direction or another can be converted into a binary sequence, for example, 0 and 1. Determining of magnetization structure of the magnetic layer of the magnetic information label for the purpose of subsequent conversion into symbolic sequences can be carried out with the help of magneto-optical converters or other devices and methods known from prior art.

The density of information recorded on the magnetic information label which can be defined as the maximum number of areas (domains, pixels) of the magnetic information label (magnetization of which may vary) depends on several factors. Let's consider the simplest part of the magnetic information label consisting of two such adjacent areas (domains, pixels) where it is necessary to provide different magnetization. To do this, one of the options requires selective heating of one of these areas, and another option requires sequential heating of the first area and then after cooling the first one of the second area.

Heating of one area (located among other areas) is provided by the electromagnetic radiation stream in the form of a beam in the cross section of which the electromagnetic radiation stream has the power to heat a particular area (domain, pixel) to a specified temperature during the predetermined time. The width(area) of the beam with such cross-section power close by the magnetic information label should exceed the width(area) of the area to be heated (domain, pixel) since the larger width(area) neighbouring areas (domains, pixels) will be heated to more extent.

Furthermore, restrictions are also imposed on properties of the material from which the magnetic layer and the entire magnetic information label in general are fabricated. In particular, when a separate area (domain, pixel) is heated up to a specified temperature, the heat transfer in the material of the magnetic information label will be observed (mainly due to a convection mechanism) in the neighbouring areas (domains, pixels) of the magnetic information label. In this case, there may be such heating of neighbouring areas (domains, pixels) or parts thereof that their temperature required to ensure the formation of the necessary magnetization (or its absence) as well as that temperature in the target area (domain, pixel) will be reached or exceeded. Since the magnetic field is highly extended, the required magnetization or its absence will be provided not only in the area (domain, pixel) where it is needed, but also in those areas (domains, pixels) or parts thereof where it is undesirable. The present invention allows to prevent such situation using described below measures.

Let us assume that one part of the magnetic information label was heated by electromagnetic radiation to a given temperature required for magnetic recording, and a neighbouring part of the magnetic information label has a lower temperature due to the fact that it was not heated by electromagnetic radiation. Then, in order for the recorded magnetic field structure to have necessary configuration, heat transfer from heated area to non-heated area must be such that non-heated area has a temperature lower than the Curie point and/or lower than the magnetization relaxation temperature, in order that previously created magnetization is retained.

Increased temperature in a heated area will initiate heat transfer processes. In order that heat from heated area of the magnetic layer does not transfer to unheated area of the magnetic layer it is necessary to ensure that it transfers from the magnetic layer to the magnetic layer carrier. Therefore, thermal absorption coefficient of the carrier must be greater than that of the magnetic layer, so that heat will transfer to the carrier faster than to a neighbouring area of the magnetic layer.

The thermal absorption coefficient s is determined by the following formula:

$$s = \sqrt{\frac{2 π λ ρ c}{T}}$$

where λ—thermal conductivity coefficient, ρ—density of the material, c—specific thermal capacity, T—thermal vibrations period. Since thermal absorption coefficients should be compared at the same periods of thermal vibrations T, the above condition, i.e. that thermal absorption coefficient of the carrier should be greater than that of the magnetic layer, can be put down as follows:

\sqrt{λ_{c}ρ_{c}c_{c}}>\sqrt{λₘρₘcₘ}

where λ_{c}—thermal conductivity coefficient of the carrier, ρ_{c}—density of the carrier, c_{c}—specific thermal capacity of the carrier, λₘ—coefficient of thermal conductivity of the magnetic layer, ρₘ—density of the magnetic layer, cₘ—specific thermal capacity of the magnetic layer.

Since the value of \sqrt{λpc} is called a thermal activity coefficient, the above condition regarding thermal absorption coefficients can be reformulated as follows: thermal activity coefficient of the carrier should be greater than that of the magnetic layer.

Since the values of 2, p and c are all real and positive, we can exclude in comparison expression square root extraction operations in both sides of the inequality whereafter the above condition can be put down as follows:

λ_{c}ρ_{c}c_{c}>λₘρₘcₘ

In other words, in order that the magnetic information label can be used to record information on it by heating it with electromagnetic radiation (with a given spatial structure) up to or above the Curie temperature (by applying the required magnetic field to the area of the magnetic information label location, or without it) and/or temperature of relaxation of magnetization, product of thermal conductivity coefficient by density and specific thermal capacity of the carrier (to be more precise, of the material from which it is made) on which the magnetic layer of the magnetic information label is located, should exceed product of thermal conductivity coefficient by density and specific thermal capacity of the magnetic layer (i.e. material from which it is made).

The carrier can be made of different materials such as paper, glass, ceramics, polymers etc. The magnetic layer can also be made of various materials including those listed above but its fabrication requires use of ferromagnetic material or several ferromagnetic materials such as ferromagnetic metals (e.g. iron, cobalt, nickel, gadolinium etc.), ferromagnetic compounds (e.g. Fe3AI, Ni3Mn, TbN, DyN, EuO etc.), or other metallic and non-metallic compounds that exhibit ferromagnetic properties.

In some options the magnetic layer can be made entirely from ferromagnetic materials but this may lead to undesirable thermal characteristics (e.g. increased thermal conductivity etc) of the magnetic layer and/or its undesirable mechanical characteristics, such as stiffness, fragility etc. In view of this, it is preferable to fabricate a combined magnetic layer consisting of a filler that sets necessary mechanical properties of the magnetic layer, such as flexibility, elasticity, hardness etc, and ferromagnetic particles that set necessary magnetic properties of the magnetic layer, such as magnetic field strength, magnetic susceptibility etc.

Thermal properties of the combined magnetic layer will be set by all its components. At the same time, volume and mass of the filler are usually much higher than that of ferromagnetic particles, so it can be said that thermal properties of the combined magnetic layer are generally determined by properties of the filler. Thus, in order to determine whether the magnetic information label is compliant with the present invention it is often necessary to compare properties of materials from which the filler and the carrier are fabricated.

In some cases, the filler and the carrier can be fabricated from the same type of material, such as paper, polymers etc. It is worth to note that different types of the same material may have different mechanical and thermal properties. For example, paper may vary in density, porosity, thermal conductivity and other properties. Polymers, in addition to these properties, may also differ in type and degree of polymerization, inclusions (such as soot, dyes, plasticizers etc.) and other factors that may also affect mechanical and thermal properties of materials.

In the above relationships of thermal absorption coefficients, thermal activity coefficients or products of thermal conductivity coefficients by material density and specific thermal capacity of one of the components is specific thermal capacity. However, the result of the process of information recording implemented by the present invention may also be influenced by share of thermal capacities not specific but total, depending on mass, volume etc.

After the heat from the heated area of the magnetic layer starts to transfer mainly to the carrier due to its higher coefficient of thermal activity, the carrier starts to heat up. If it heats up quickly due to low thermal capacity (e.g. if the carrier is thin enough), not only will carrier area adjacent to the heated area of the magnetic layer be heated but also a large transfer of heat will happen from this area of the carrier to neighbouring areas of the carrier adjacent to those areas of magnetic layer where no heating by electromagnetic radiation occurs.

This will result in that those areas of the magnetic layer heating of which was not required and, therefore, electromagnetic radiation was not being heated, will be heated from the carrier and may be heated up to or above the Curie temperature and/or magnetisation relaxation temperature, and this may lead to distortion of recorded magnetic field structure.

This undesirable heating can be eliminated by ensuring that heat received by the carrier is distributed not only in the area of the carrier adjacent to non-heated areas of the magnetic layer, but also in those areas of the carrier that are located well out from the magnetic layer, i.e. in layers of the carrier that are parallel to and distant from the magnetic layer. For this purpose it is possible to provide greater thickness of the carrier layer. Since the magnetic layer perceives electromagnetic radiation and is heated up more intensively than the carrier, and the carrier's thermal activity coefficient is higher than that of the magnetic layer, effective distribution of heat deep into the carrier prevents undesirable heating of areas of the magnetic layer where heating is not required, possibly provided that the carrier layer is thicker than that of the magnetic layer. This results in higher thermal capacity of the carrier compared to that of the magnetic layer.

In another option higher thermal capacity of the carrier compared to that of the magnetic layer can be provided with an increased specific thermal capacity of the material from which the carrier is fabricated, compared to that of the material from which the magnetic layer is fabricated. This will also increase thermal activity coefficient of the carrier.

The magnetic information label can be fabricated in a multilayer form and contain both the magnetic layer and the carrier layer of magnetic layer carrier. In some options such multilayer magnetic information label can be equipped with an adhesive layer on the carrier layer to enable the magnetic information label to be glued to an object or product. The magnetic information label may also contain another adhesive layer between the magnetic layer and the carrier in order to securely fixate the magnetic layer to the carrier.

The magnetic information label can also be fabricated as a magnetic layer placed on the carrier as a marked object or product. If the magnetic layer has sufficient adhesion to a marked object or product, it can be applied directly. However, in some cases, for a secure fixation an adhesive layer between the magnetic layer and the carrier may be required.

As for adhesive layer between the magnetic layer and the carrier (presented both in label and as a marked object or product), to ensure the possibility of recording information the same condition relative to the magnetic layer as for the carrier relative to the magnetic layer is imposed. That is, product of thermal conductivity coefficient by material density and specific thermal capacity of the adhesive layer applied to the magnetic layer (between the magnetic layer and the carrier) should be larger than product of thermal conductivity coefficient by material density and specific thermal capacity of the magnetic layer.

In other words, thermal absorption coefficient of the adhesive layer applied to the magnetic layer (between the magnetic layer and the carrier) must be greater than thermal absorption coefficient of the magnetic layer. Or, alternatively, thermal activity coefficient of the adhesive layer applied to the magnetic layer (between the magnetic layer and the carrier) must be greater than thermal activity coefficient of the magnetic layer.

The adhesive layer between the magnetic layer and the carrier when performing function of transfer of heat from the magnetic layer to the carrier may be thin and, thus, not accumulate heat. To ensure effective transfer of heat from the magnetic layer to the carrier through the glue layer, in addition to the above relationships of properties of the magnetic layer and the glue layer, it is necessary to ensure that additional condition is met which allows for effective heat transfer from the glue layer to the carrier. This condition is that product of thermal conductivity coefficient by material density and specific thermal capacity of the carrier must be no less than product of thermal conductivity coefficient by material density and specific thermal capacity of the adhesive layer located between the magnetic layer and the carrier.

In other words, thermal absorption coefficient of the carrier must be no less than thermal absorption coefficient of the adhesive layer located between the magnetic layer and the carrier. Or, alternatively, thermal activity coefficient of the carrier must be no less than thermal activity coefficient of the adhesive layer located between the magnetic layer and the carrier.

If there are other layers between the magnetic layer and the carrier, the same conditions apply as those specified for the adhesive layer located between the magnetic layer and the carrier.

Due to the above-described ratio of thermal properties of the magnetic layer and the carrier (and as well in the presence of adhesive layer) it is possible to record information on the magnetic information label in the form of spatially structured magnetization of the magnetic layer by heating required areas (domains, pixels) with the help of spatially structured electromagnetic radiation up to temperatures that ensure establishment of the required magnetization in the absence of heating of other areas (domains, pixels) of the magnetic layer. Furthermore, the above-described ratios of thermal properties of the magnetic layer and the carrier also provide increased density of information recorded on the magnetic information label (its information density).

1. A magnetic information label for recording information, the label comprising:
a carrier and a magnetic layer attached to the carrier; and
special areas of the label to be heated up with electromagnetic radiation up to or above the Curie temperature and/or magnetization relaxation temperature; wherein a product of a thermal conductivity coefficient multiplied by a density multiplied by a specific thermal capacity of the carrier of the magnetic layer is greater than a product of a thermal conductivity coefficient multiplied by a density multiplied by a specific thermal capacity of the magnetic layer.

2. The label according to claim 1, wherein the coefficient of thermal activity of the carrier is greater than that of the magnetic layer.

3. The label according to claim 1, wherein the thermal absorption coefficient of the carrier is greater than that of the magnetic layer.

4. The label according to claim 1, wherein the thermal capacity of the carrier is greater than that of the magnetic layer.

5. The label according to claim 1, wherein a thickness of the carrier is greater than that of the magnetic layer.

6. The label according to claim 1, wherein the label is made multilayered and wherein the carrier is a carrier layer.

7. The label according to claim 6, wherein the label comprises an additional adhesive layer applied to the carrier layer.

8. The label according to claim 1, wherein the carrier is made in a shape of a marked object or product.

9. The label according to claim 1, further comprising an adhesive layer disposed between the magnetic layer and the carrier, wherein a product of a thermal conductivity coefficient multiplied by a density multiplied by a specific thermal capacity of the adhesive layer is greater than the product of the thermal conductivity coefficient multiplied by the density multiplied by the specific thermal capacity of the magnetic layer, and wherein the product of thermal conductivity coefficient multiplied by the density multiplied by the specific thermal capacity of the carrier is not less than the product of the thermal conductivity coefficient multiplied by the density multiplied by the specific thermal capacity of the adhesive layer.

10. A method of using a magnetic information label, the method comprising:
providing a magnetic layer attached to a carrier; and
heating special areas of the label by electromagnetic radiation up to or above the Curie temperature and/or magnetisation relaxation temperature to record information;
wherein a product of a thermal conductivity coefficient multiplied by a density multiplied by a specific thermal capacity of the carrier is greater than a product of a thermal conductivity coefficient multiplied by a density multiplied by a specific thermal capacity of the magnetic layer.

11. The method according to claim 10, wherein the coefficient of thermal activity of the carrier is greater than that of the magnetic layer.

12. The method according to claim 10, wherein the thermal absorption coefficient of the carrier is greater than that of the magnetic layer.

13. The method according to claim 10, wherein the thermal capacity of the carrier is greater than that of the magnetic layer.

14. The method according to claim 10, wherein a thickness of the carrier is greater than that of the magnetic layer.

15. The method according to claim 10, wherein it is made multilayered whereas the carrier of the magnetic layer is the carrier layer.

16. The method according to claim 15, further comprising providing the layer with an additional adhesive layer applied to the carrier layer.

17. The method according to claim 10, wherein the carrier is made in a shape of a marked object or product.

18. The method according to claim 10, further comprising placing an adhesive layer between the magnetic layer and the carrier, wherein a product of a thermal conductivity coefficient multiplied by a product of the thermal conductivity coefficient multiplied by the density multiplied by the specific thermal capacity of the magnetic layer, and wherein the product of thermal conductivity coefficient multiplied by the density multiplied by the specific thermal capacity of the carrier is not less than the product of the thermal conductivity coefficient multiplied by the density multiplied by the specific thermal capacity of the adhesive layer.
